(19) United States
(12) Patent Application Publication
(10) Pub. No.: US 2006/0238743 A1
(43) Pub. Date: Oct. 26, 2006

(54) Speckle reduction optical mount device

(76) Inventors: Todd E. Lizotte, Manchester, NH (US); Orest Ohar, Hooksett, NH (US); Richard Rosenberg, Londonderry, NH (US)

Correspondence Address: DAVIS & BUJOLD, P.L.L.C., 112 PLEASANT STREET, CONCORD, NH, 03301, US

(21) Appl. No.: 11/407,698

(22) Filed: Apr. 20, 2006

Related U.S. Application Data
(60) Provisional application No. 60/673,597, filed on Apr. 21, 2005.

(51) Int. Cl. G01P 3/36

(52) U.S. Cl. 356/28.5

(57) ABSTRACT

An optical mount device for holographic and diffractive beam shaped image speckle reduction by active beam sampling by means of low and high frequency vibrations induced in the HOE/DOE optical mount. A holographic optical element or a diffractive optical element is placed into an optical mount which is isolated by small flexures or springs and is moved in an x-y plane at variable frequencies ranging from 1 to 50 kHz.

### CROSS REFERENCES TO RELATED APPLICATIONS

The present Application is related to and claims benefit of U.S. Provisional Patent Application Ser. No. 60/673,597 filed Apr. 21, 2005 by Todd E. Lizotte, Orest Ohar and Richard Rosenberg for a HOLOGRAPHIC AND DIFFRACTIVE BEAM SHAPED IMAGE SPECKLE REDUCTION BY ACTIVE BEAM SAMPLING BY MEANS OF LOW AND HIGH FREQUENCY VIBRATIONS INDUCED IN A HOE/DOE OPTICAL MOUNT.

### FIELD OF THE INVENTION

The present invention relates to an optical mount device for holographic and diffractive beam shaped image speckle reduction by active beam sampling by means of low and high frequency vibrations induced in the HOE/DOE optical mount.

### BACKGROUND OF THE INVENTION

Holographic, diffractive or computer generated holographic optics used for beam shaping are typically used to shape or transform a beam with an undesirable output profile or phase, into a desirable profile or phase, such as a Gaussian laser beam profile being transformed into a Flat Top beam profile. This is especially critical when drilling microvias through multiple layers of materials of differing molecular properties and grain structures. It is also very critical when shaping a laser beam for micro-welding plastics.

Such beam shaping, however, generally results in “speckling” of the energy distribution of the shaped beam wherein speckle looks like a grainy pattern across the shaped beam area at the image plane. Speckle is generated by mutual interference of partially coherent laser beams that are subjected to small temporal and spatial fluctuations. This is compounded by beam shaping with HOE or DOE elements which result in speckle patterns due to superposition of mode field patterns.

When drilling microvias in differing material layers or laminations, the speckle pattern could be significant enough to create partial drilling of the material leaving an undesirable level of surface texture and roughness or partial drilling of features, which either requires more laser pulses or the need for trepanning the laser beam to average out the speckle pattern. Trepanning significantly increases the time to produce the microvias which translates into more time and cost associated with manufacture of a multi-layered printed circuit board.

Speckle is also a potentially significant problem when micro-welding and specifically micro-welding plastic devices such as multiple layers of a thin plastic used for medical applications as there is a need to create a seal that can handle significantly large pressures, typically in excess of 90 PSI. If a speckle pattern occurs within the image of the shaped laser beam at the target plane where the micro-welding occurs, then there is a chance for a void path that could form a leak. In the case of critical micro welds, this could lead to unacceptable failures of medical devices during a medical procedure. Such voids could also trap air or moisture, which could later expand during freezing or create a health risk by trapping contaminants.

The reduction of speckle is beneficial for other processes as well including photo resist writing and exposure, laser sintering metals and ceramics or photo polymer based stereo-lithography techniques, laser trimming of thin films of IC chips or fuses, laser welding of automotive components both plastic and metals, laser sealing of glass or polymer frit material used in flat panel displays and laser processes for generating photonic crystals.

### SUMMARY OF THE INVENTION

To reduce the effects of speckle, a computer generated holographic optical element or a diffractive optical element is placed into an optical mount which is isolated by small flexures or springs. This optical mount isolated by small flexures or springs, i.e., a flexure/spring mount, allows the optical element to be moved in an x-y plane at variable frequencies ranging from 1 to 50 kHz and movement from 1 micron to several tens of millimeters. This device is called a Speckle Reduction Optical Mount, or SROM, and allows the HOE or DOE to be sampled by the incoming illuminating laser beam once every pulse or once every set number of pulses. By sampling the HOE or DOE optic, through illuminating the optic at several various positions, the speckle pattern is reduced and the integrated effect is a more uniform pattern on target.

The mount can be outfitted with simple linear servo actuators for lower range frequencies, voice coil linear actuators for mid range frequencies or the mount can be outfitted with piezo linear actuators for high frequencies upward of >30 kHz, for example.

The HOE or DOE shaper located in this mount is placed within a beam delivery system used for focal point machining or mask imaging. The mount is then connected to the motion controller and laser pulsing circuit to allow for either open or closed loop synchronized pulsing of the laser with the motion of the optic housed with the SROM. By setting the frequency of random oscillations or a specific pattern of motion, the SROM allows the HOE or the DOE optic to be sample to reduce speckle on target.

### BRIEF DESCRIPTION OF THE DRAWINGS

FIG. 1A illustrates a prior art method for transforming a Gaussian Beam into a Flat Top profile at the image plane with Computer Generate Hologram (CGH), and the resulting speckling;

FIG. 1B is an enlarged view of area A of FIG. 1A;

FIG. 2A shows a Speckle Reduction Optical Mount with the same CGH used in FIG. 1A;

FIG. 2B is an enlarged view of area A of FIG. 2A;

FIG. 3 is a control schematic for sending a random signal to the Speckle Reduction Optical Mount “SROM”;

FIG. 4 is a laser process machine using a SROM;

FIG. 5 is a fiber optic delivered micro/welding head or cutting head into which a SROM can be configured;

FIG. 6A is a diagrammatic cross sectional view of a hole processed without use of a SROM;

FIG. 6B is a diagrammatic cross sectional view of a hole processed with use of a SROM;

FIG. 7 is a multi-beam aperture imaging system for drilling microvias with a SROM;

FIG. 8 is a diagrammatic view showing how a SROM would perform when used with an aperture in a mask imaging optical beam delivery system;

FIG. 9A shows a shaped laser beam profile without high frequency oscillation of the SROM of FIG. 8; and

FIG. 9B shows a shaped laser beam profile with high frequency oscillation of the SROM of FIG. 8.

### DESCRIPTION OF THE PREFERRED EMBODIMENT

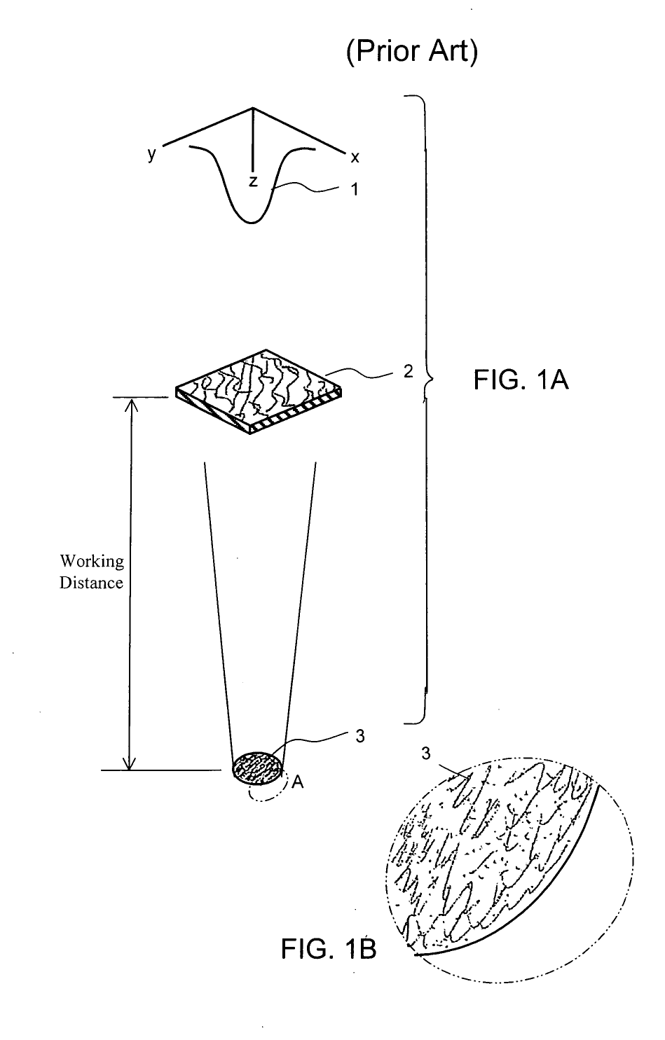

FIG. 1A shows a Computer Generate Hologram Beam Shaper (CGH) 2 being illuminated by a Gaussian Beam 1 wherein the CGH is transforming the beam 1 into a shaped image 3 at the image plane and where the speckle pattern that develops in the shaped image 3 is illustrated, in further detail in FIG. 1B.

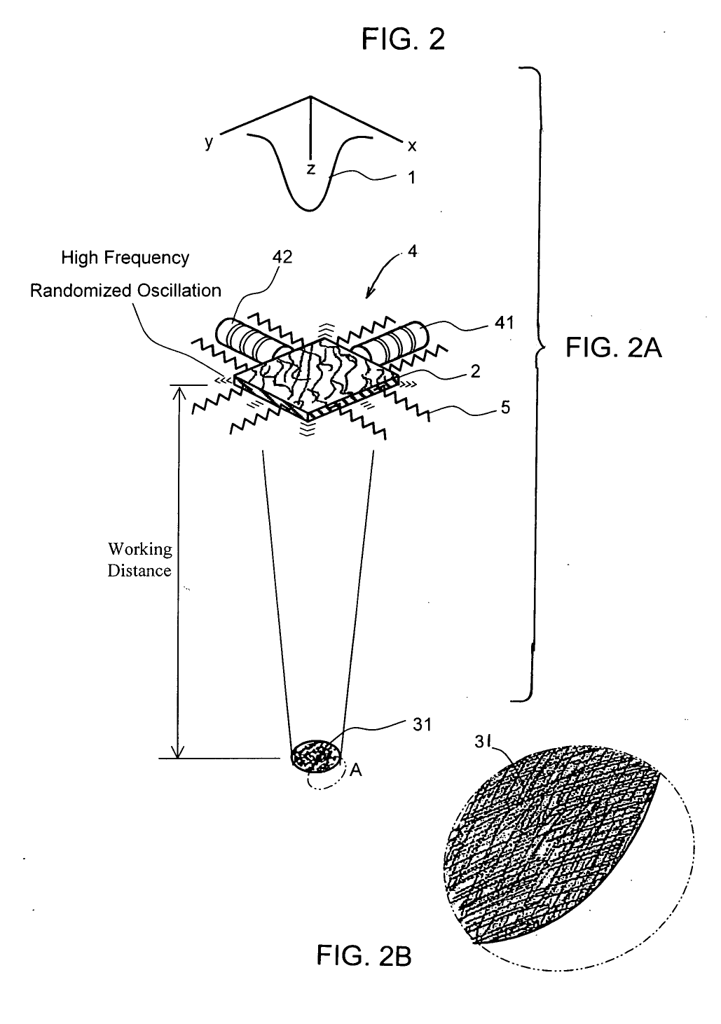

FIG. 2A shows the same CGH 2 used in FIG. 1, except that the CGH 2 is now mounted to a Speckle Reduction Optical Mount (SROM) 4, of the present invention, and the reduction in speckle noise is illustrated in further detail in FIG. 2B. As shown, Speckle Reduction Optical Mount 3 contains piezo linear actuators 41 and 42, and a number of opposed flexures or springs 5, which can randomly oscillate the CGH 2 at variable high frequencies ranging from about 1 to about 50 kHz, for example.

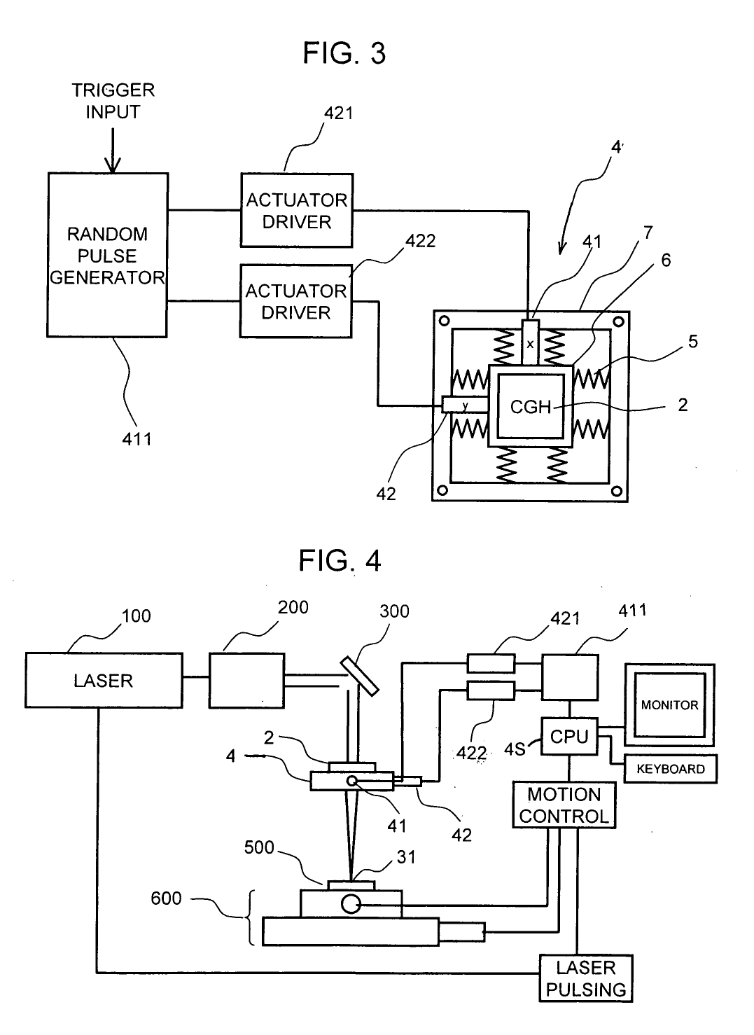

FIG. 3 shows a control circuit 411 for SROM 4 wherein the control circuit includes a random pulse generator 411 for generating and sending a random signal to actuator control drives 421 and 422 for the x and y axis of SROM 4. As shown, SROM 4 again comprises piezo linear actuators 41 and 42, a number of opposed flexures or springs 5, a mount 6 for mounting a CGH 2, and a frame 7. The random pulse generator 411 generates random pulses to actuate the linear actuators through the actuator drivers by a trigger input.

FIG. 4 shows how a SROM 4 can be integrated into a simple laser process where x-y table 600 motion and laser 100 pulsing can be synchronized with the SROM 4 for optimum process control. The same reference numeral are retained for similar component appearing in FIG. 3 and the description thereof is omitted. A laser beam is emitted from a laser 100 and this laser beam is then conditioned by conditioning optics 200, deflected by steerable mirrors 300, shaped by a CGH 2 on a SROM 4, and directed onto a workpiece 500, which is mounted on a x-y table 600 or some other movable fixture. The x-y table 600 motion and the laser 100 pulsing can be synchronized with the SROM 4 by a CPU 4S.

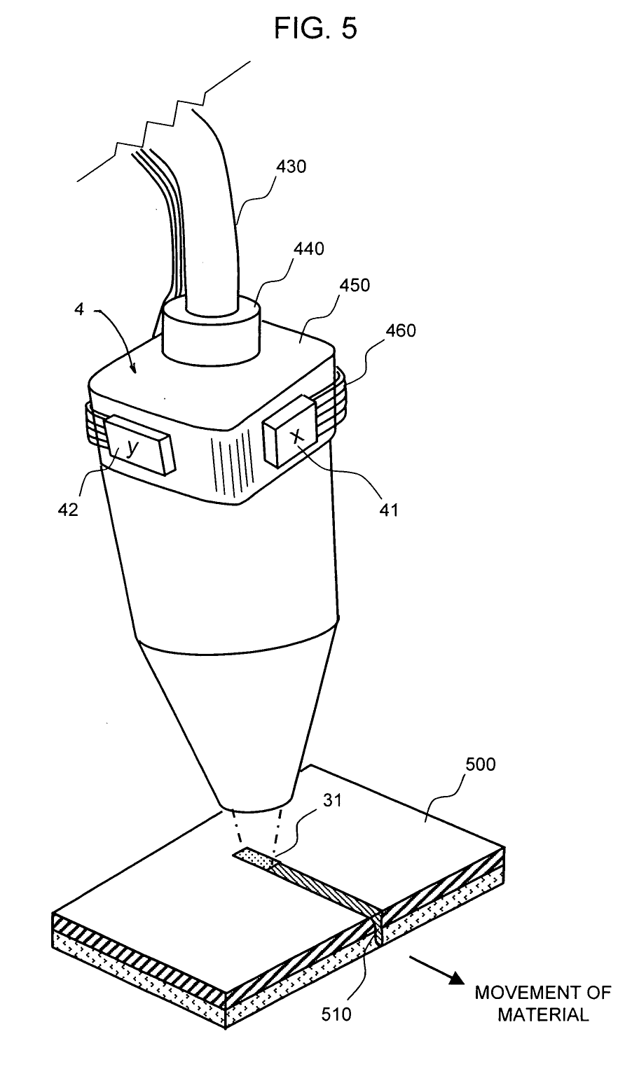

FIG. 5 shows how a SROM 4 can be configured into a fiber optic delivered micro/welding head or cutting head. A housing 450 accommodates a SROM 4 internally, and the linear actuators 41 and 42 protrude from and are and connected to suitable drive cables 460. One end of a fiber delivery of laser 430 is connected, via a fiber optical connector 440, to the housing 450 accommodating a SROM 4 for supplying the laser thereto. A shaped laser beam 31 is sampled at a high frequency and output onto a workpiece 500, which is a multilayer material that is to be at least one of weld, bonded, and/or staked 510, for example.

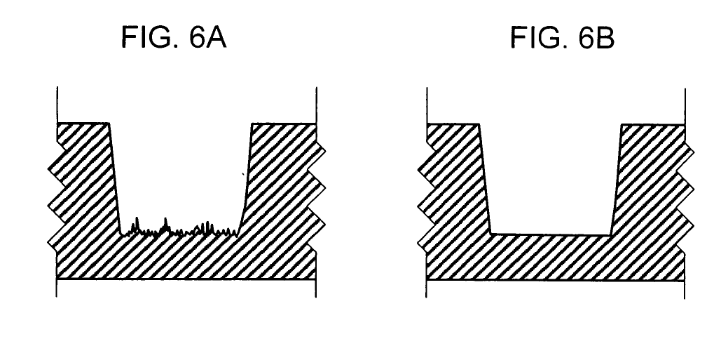

FIGS. 6A and 6B, respectively, show how a cross section hole would look like without the use of a SROM 4 and with use of a SROM 4. FIG. 6A is a cross sectional view of a hole processed without the use of a SROM 4 and, as can be seen, the effects of speckle appear as an irregular machined surface. FIG. 6B is a cross sectional view of a hole processed using a SROM 4 which substantially eliminates, or minimizes at the very least, the effects of speckle.

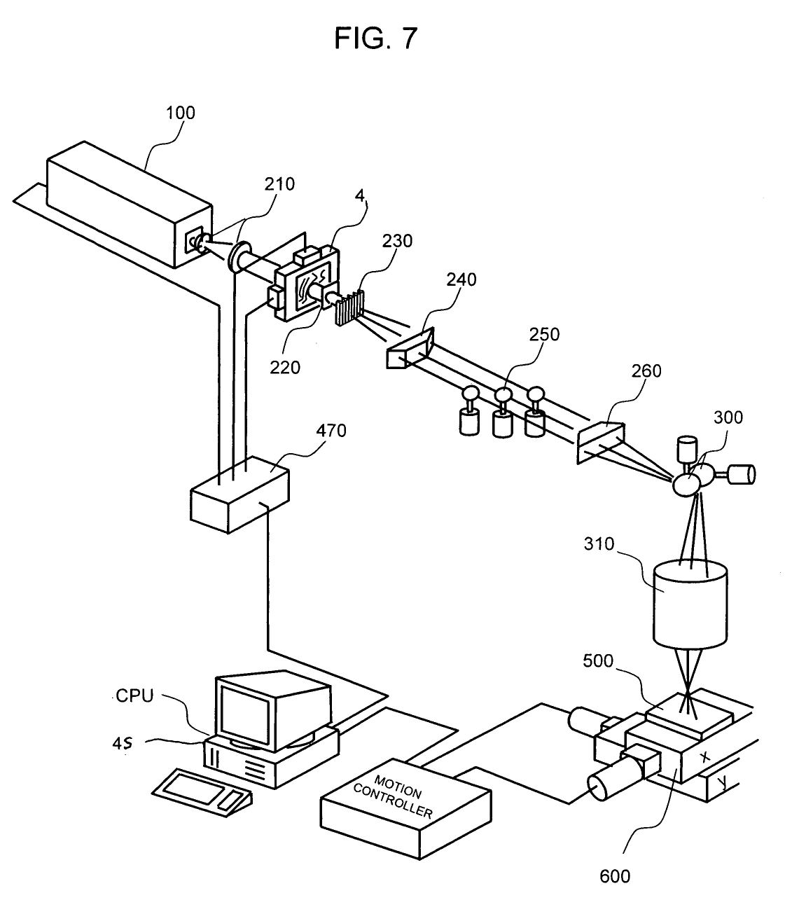

FIG. 7 shows how a SROM 4 can be used in a multi-beam aperture imaging system for drilling microvias. A laser beam is emitted from a laser 100, conditioned by a conditioning optics “TELESCOPE” 200, shaped by a CGH 2 on a SROM 4, passed through an aperture mask 220, split into beams by a beam splitter 230 and then collimated by a collimating prism 240. Thereafter, the collimated beams are individually switched by shutters 250, converged by a converging prism 260, deflected by galvanometer mirrors 300 through an Fθ lens, and then finally directed onto a multilayer workpiece 500 which is mounted on a x-y table 600 or some suitable other fixture. A laser-high frequency optic oscillator synchronization box 470 is used to synchronize laser pulses to DOE/HOE oscillations.

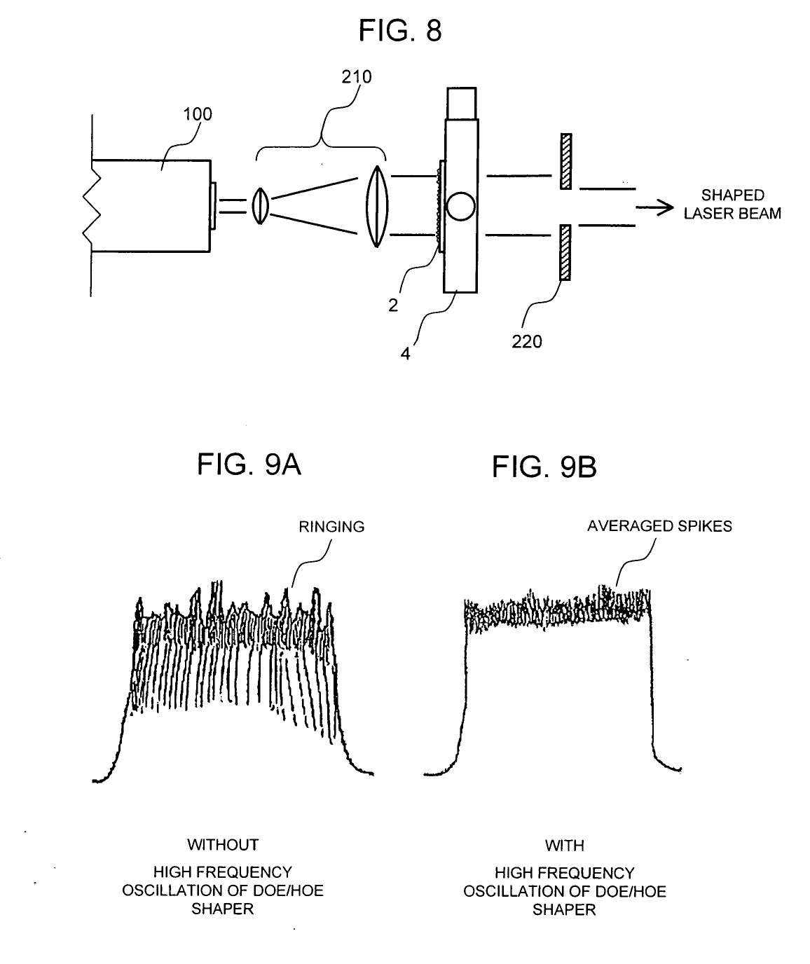

FIG. 8 shows how a SROM 4 would perform when used with an aperture in a mask 220 imaging optical beam delivery system for microvia drilling or laser trimming of thin films. FIG. 9A shows a shaped laser beam profile without the high frequency oscillation of the SROM of FIG. 8 and indicates that the resulting profile has intensity spikes, designated as ringing in FIG. 9A. FIG. 9B shows a shaped laser beam profile with high frequency oscillation of the SROM of FIG. 8 and, as can be seen, the profile is indicated as having “averaged spikes.”

Since certain changes may be made in the above described invention without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An optical mounting device for speckle reduction in holographic and diffractive beam shaping, the optical mounting device comprising:
a mount for mounting one of a holographic and diffractive beam shaper;
linear actuators for oscillating the mount for x and y direction respectively;
spring means for isolating the mount; and
a frame for fixing the spring means.

2. The optical mounting device according to claim 1, wherein the linear actuators are piezo linear actuators.

3. The optical mounting device according to claim 1, wherein the linear actuators are voice coil linear actuators.

4. A speckle reduction system for holographic and diffractive beam shaping, the speckle reduction system comprising:
a mount for mounting one of a holographic and diffractive beam shaper;
linear actuators for oscillating the mount for x and y direction respectively;
spring means for isolating the mount;
a frame for fixing the spring means;
an aperture mask;
actuator drivers for driving the linear actuators; and
a random pulse generator for generating random pulses to actuate the linear actuators through the actuator drivers by a trigger input.

5. An optical mounting device for speckle reduction in holographic and diffractive beam shaping, the optical mounting device comprising:
a resiliently supported mount for mounting one of a holographic and diffractive beam shaper; and
linear actuators for oscillating the mount for x and y direction respectively to average the speckle over an area of a shaped beam.

6. The optical mounting device according to claim 5, wherein the linear actuators are piezo linear actuators.

7. The optical mounting device according to claim 5, wherein in which the linear actuators are voice coil linear actuators.

8. A method for speckle reduction in laser beam shaping, the method comprising the steps of:
generating a laser beam;
passing the laser beam through a resiliently supported beam shaping element in which the beam shaping element is one of a holographic and diffractive beam shaping element; and
oscillating the resiliently supported beam shaping element along axes orthogonal to an axis of the shaped beam to average speckle effects across an area of the shaped beam.
